(19) United States
(12) Patent Application Publication
(10) Pub. No.: US 2025/0355097 A1
(43) Pub. Date: Nov. 20, 2025

(54) SIMULATION TEST METHOD BASED ON A ROTATING PRISM LIDAR AND A DEVICE THEREOF

(71) Applicant: CHANG'AN UNIVERSITY, Xi'an City (CN)

(72) Inventors: Xiangmo ZHAO, Xi'an City (CN); Zhen WANG, Xi'an City (CN); Cheng PENG, Xi'an City (CN); Jingjun CHENG, Xi'an City (CN); Pengchao LIU, Xi'an City (CN); Jianquan CHEN, Xi'an City (CN); Bo DAI, Xi'an City (CN); Jiaping WANG, Xi'an City (CN); Shaobo LI, Xi'an City (CN); Yazhou LI, Xi'an City (CN)

(21) Appl. No.: 18/827,633

(22) Filed: Sep. 6, 2024

(30) Foreign Application Priority Data
Jan. 24, 2024 (CN) 202410097675.6

(51) Int. Cl. G01S 7/497

(52) U.S. Cl. CPC G01S 7/497

(57) ABSTRACT

A simulation test method based on a rotating prism Lidar and a device thereof are provided. The simulation test method based on the rotating prism Lidar includes: obtaining a scanning trajectory model of a Lidar signal on an imaging plane, and the Lidar signal is emitted by a rotating prism Lidar; acquiring an attenuation coefficient of the Lidar signal propagating in a preset weather environment, and determining an echo signal model of the Lidar signal in the preset weather environment according to the attenuation coefficient; performing a simulation test on the rotating prism Lidar based on the scanning trajectory model and the echo signal model, and achieving the simulation test on a working process of the rotating prism Lidar.

### CROSS REFERENCE TO RELATED APPLICATIONS

This application claims foreign priority of Chinese Patent Application No. 202410097675.6, filed on Jan. 24, 2024 in the China National Intellectual Property Administration, the disclosures of all of which are hereby incorporated by reference.

### TECHNICAL FIELD

The present disclosure relates to the technical field of Lidar technology, in particular to a simulation test method based on a rotating prism Lidar and a device thereof.

### BACKGROUND

The virtual simulation environment can provide highly controllable test scenarios, while simulating a variety of complex traffic conditions and environmental conditions, so as to evaluate the performance and safety of autonomous vehicles more comprehensively. In virtual simulation tests, the accuracy and authenticity of the sensor model are crucial for the reliability of the test results. Lidar is one of commonly used sensing sensors in autonomous vehicles, which can obtain distance and depth of the target object in surrounding environment in real time.

Rotating prism Lidar is an important class of solid-state Lidar, in the field of autonomous vehicles has unique advantages, but the rotating prism Lidar application in autonomous vehicles is not mature. In order to evaluate actual measurement effect of the rotating prism Lidar in the field of autonomous vehicle, it needs to perform the rotating prism Lidar simulation test. However, due to the complexity of the rotating prism Lidar structure, there is still lack of simulation test methods for the working performance of the rotating prism Lidar in the related technology currently.

### SUMMARY

The present disclosure provides a rotating prism Lidar and a device thereof, aims to achieve simulation test during a working process of the rotating prism Lidar.

To realize the above objective, the present disclosure provides a simulation test method based on a rotating prism Lidar, including:
S10: obtaining a scanning trajectory model of a Lidar signal on an imaging plane, and the Lidar signal is emitted by a rotating prism Lidar; and
S20: acquiring an attenuation coefficient of the Lidar signal propagating in a preset weather environment, and determining an echo signal model of the Lidar signal in the preset weather environment according to the attenuation coefficient; and
S30: performing a simulation test on the rotating prism Lidar based on the scanning trajectory model and the echo signal model.

In one embodiment, in S10, the scanning trajectory model is expressed as follow:

$$\{ \begin{matrix}{x}_{L} ( t ) = L ( 2 cos {Ω}_{1} t \cdot sin {δ}_{1} \cdot [ 1 - {cos}^{2} {Ω}_{1} t ( 1 - cos {δ}_{1} ) ] + sin {δ}_{2} cos {Ω}_{2} t ) \\ {y}_{L} ( t ) = L ( 2 {cos}^{2} {Ω}_{1} t \cdot sin {Ω}_{1} t \cdot sin {δ}_{1} ( 1 - cos {δ}_{1} ) - sin {Ω}_{1} t sin {δ}_{1} cos {δ}_{1} + cos {δ}_{2} sin {Ω}_{2} t )\end{matrix} ;$$

wherein, x_{L}(t) is a scanning trajectory in a x-axis direction, and y_{L}(t) is a scanning trajectory in a y-axis direction at a time t, and t is the time, and Ω₁ is a rotating speed of a pair of synchronous prisms, and δ₁ is a laser beam deflection angle caused by one synchronous prism of the pair of the synchronous prisms, and Ω₂ is a rotating speed of an independent rotating prism, and δ₂ is a laser beam deflection angle caused by the independent rotating prism, and L is a distance between the Lidar and the imaging plane.

In one embodiment, in S20, the attenuation coefficient is expressed as follow:

$${β}_{atm} = - ( \frac{0.18126 {λ}_{μ m}^{2} + 0.13709 {λ}_{μ m} + 3.7502}{V} + {ah}^{b} + 1.3029 \frac{m}{{C}_{snow}} ) \cdot 2 R ;$$

and
wherein, βₐₜₘ is the corresponding attenuation coefficient of the Lidar signal propagating in preset weather environment, and C_{snow} is a snowfall coefficient, and V is visibility, and λ_{μm} is a wavelength of the Lidar signal, and R is a laser transmission distance, a and b are rainfall intensity coefficients, his precipitation, and m is a water content of snowflakes.

In one embodiment, in S20, the echo signal model is expressed as follow:

$${s}_{rec} ( t ) = A {\int }_{{t}_{1}}^{{t}_{2}} {β}_{atm} l ( τ - t ) \int \int {p}_{0} ( x , y , {R}_{0} ) a ( x , y , {R}_{0} , τ - t ) dxdyd τ$$

and
wherein, s_{rec}(t) the echo signal, and Ais a signal amplification of a rectangular signal in a time period of t₁ to t₂, and t is a current time, and t₁ is an emission time of a rectangular signal, and t₂ is an end time of the rectangular signal, and τ is a convolution integral variable, and p₀(x, y, R₀) is a surface reflectivity function of a target object, and a (x, y, R₀, τ−t) is an energy distribution function of the Lidar signal on a beam section.

In one embodiment, the S30 includes following steps:
S31: obtaining a detecting path of the Lidar signal in a simulation test scenario according to the scanning trajectory model of the Lidar signal, and acquiring an echo signal of the Lidar signal propagating in the preset weather environment according to the echo signal model; and
S32: performing the simulation test on a working process of the rotating prism Lidar based on the detecting path and the echo signal.

In one embodiment, in S2, the attenuation coefficient is expressed as follow:

$${β}_{atm} = - ( {β}_{fog} + {β}_{rain} + {β}_{snow} ) 2 R ;$$

wherein, βₐₜₘ is the attenuation coefficient of the Lidar signal in the preset weather environment, and β_{fog} is an attenuation coefficient of the Lidar signal in foggy weather, and βᵣₐᵢₙ is an attenuation coefficient of the Lidar signal in rainy weather, and β_{snow} is an attenuation coefficient of the Lidar signal in snowy weather, and R is the laser transmission distance.

Further, the present disclosure also provides a simulation test device based on a rotating prism Lidar, including:
a first obtaining unit, configured for obtaining a scanning trajectory model of a Lidar signal on an imaging plane, and the Lidar signal is emitted by a rotating prism Lidar; and
a second obtaining unit, configured for acquiring an attenuation coefficient of the Lidar signal propagating in a preset weather environment, and determining an echo signal model of the Lidar signal in the preset weather environment according to the attenuation coefficient; and
a processing unit, configured for performing a simulation test on the rotating prism Lidar based on the scanning trajectory model and the echo signal model.

In one embodiment, the scanning trajectory model is expressed as follow:

$$\{ \begin{matrix}{x}_{L} ( t ) = L ( 2 cos {Ω}_{1} t \cdot sin {δ}_{1} \cdot [ 1 - {cos}^{2} {Ω}_{1} t ( 1 - cos {δ}_{1} ) ] + sin {δ}_{2} cos {Ω}_{2} t ) \\ {y}_{L} ( t ) = L ( 2 {cos}^{2} {Ω}_{1} t \cdot sin {Ω}_{1} t \cdot sin {δ}_{1} ( 1 - cos {δ}_{1} ) - sin {Ω}_{1} t sin {δ}_{1} cos {δ}_{1} + cos {δ}_{2} sin {Ω}_{2} t )\end{matrix} ;$$

wherein, x_{L}(t) is a scanning trajectory in a x-axis direction at, and y_{L}(t) is a scanning trajectory in a y-axis direction, and t is a current time, and Ω₁ is a rotating speed of synchronous prism pairs, and δ₁ is a laser beam deflection angle caused by one synchronous prism of a pair of synchronous prisms, and Ω₂ is a rotating speed of an independent rotating prism, and δ₂ is a laser beam deflection angle caused by the independent rotating prism, and Lis a distance between the Lidar and the imaging plane.

In one embodiment, the echo signal model is expressed as follow:

$${s}_{rec} ( t ) = A {\int }_{{t}_{1}}^{{t}_{2}} {β}_{atm} l ( τ - t ) \int \int {p}_{0} ( x , y , {R}_{0} ) a ( x , y , {R}_{0} , τ - t ) dxdyd τ$$

and
wherein, s_{rec}(t) the echo signal, and A is a signal amplification of a rectangular signal in a time period of t₁ to t₂, and tis a current time, and t₁ is an emission time of rectangular signal, and t₂ is the end time of the rectangular signal, and τ is a convolution integral variable, and p₀(x, y, R₀) is a surface reflectivity function of the target object, and a (x, y, R₀, τ−t) is an energy distribution function of the Lidar signal on a beam section.

Furthermore, the present disclosure also provides a computer readable storage medium, the computer readable storage medium comprises a simulation test program based on a rotating prism Lidar, when a simulation test program based on a rotating prism Lidar is called by a processor, a simulation test method based on a rotating prism Lidar mentioned above is achieved.

According to the simulation test method based on the rotating prism Lidar of the present disclosure, obtaining a scanning trajectory model of a Lidar signal on an imaging plane, and the Lidar signal is emitted by a rotating prism Lidar; acquiring an attenuation coefficient of the Lidar signal propagating in a preset weather environment, and determining an echo signal model of the Lidar signal in the preset weather environment according to the attenuation coefficient; performing a simulation test on the rotating prism Lidar based on the scanning trajectory model and the echo signal model, and achieving the simulation test on the working process of the rotating prism Lidar.

### BRIEF DESCRIPTION OF THE DRAWINGS

FIG. 1 is a structure diagram of a simulation test equipment based on a rotating prism Lidar according to an embodiment of the present disclosure;

FIG. 2 is a flow diagram of a simulation test method based on a rotating prism Lidar according to an embodiment of the present disclosure;

FIG. 3 is a structure diagram of the prism Lidar system according to an embodiment of the present disclosure;

FIG. 4 is a structure diagram of a pair of synchronous prisms and laser beam deflection according to an embodiment of the present disclosure;

FIG. 5 is a schematic diagram of an independent rotating prism laser beam deflection according to an embodiment of the present disclosure;

FIG. 6 is a schematic diagram of a laser beam echo principle according to an embodiment of the present disclosure;

FIG. 7 is a schematic diagram of a scanning mode of a virtual sensor output according to an embodiment of the present disclosure;

FIG. 8 is a schematic diagram of a digital twin scenario modeling process according to an embodiment of the present disclosure;

FIGS. 9A-9B are a virtual scene according to an embodiment of the present disclosure;

FIGS. 9C-9D are another virtual scene according to an embodiment of the present disclosure;

FIG. 10 is a structure diagram of a simulation test device based on a rotating prism Lidar according to an embodiment of the present disclosure.

The realization of the objects, functional features and advantages of the present disclosure will be further described in combination with embodiments with reference to the drawings.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

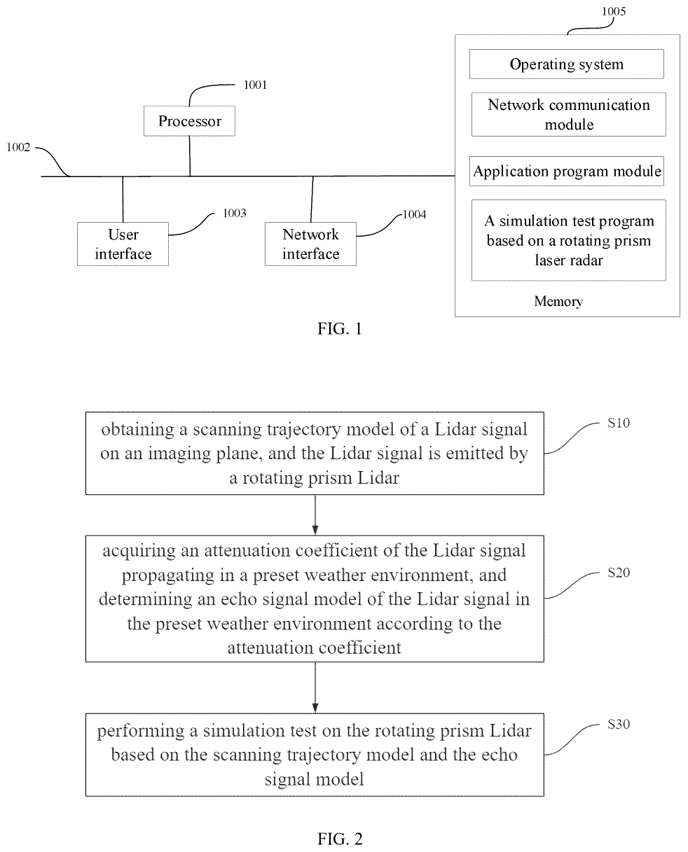

Referring to FIG. 1, FIG. 1 is a structure diagram of a simulation test equipment based on a rotating prism Lidar according to an embodiment of the present disclosure.

As shown in FIG. 1, the simulation test equipment based on a rotating prism Lidar includes: a processor 1001 (such as central processing unit, CPU), a communication bus 1002, and a user interface 1003, and an internet interface 1004, and a memory 1005. Among them, the communication bus 1002 is used to achieve connection communication between these components; the user interface 1003 may include a display screen, input units such as a keyboard, and optional user interfaces 1003 may also include standard wired and wireless interfaces. The network interface 1004 may include a standard wired interface, a wireless interface (such as wireless-fidelity (WI-FI) interface) and the memory 1005 can be high-speed RAM memory or non-volatile memory, such as disk memory, non-transitory computer-readable storage medium. Optionally, memory 1005 is a storage device independent of the aforementioned processor 1001.

Technical personnel in this field can understand that the structure shown in FIG. 1 does not constitute a limitation on the simulation test equipment based on the rotating prism Lidar. It may include more or fewer components than shown in the diagram, or combine certain components, or arrange in different components.

As shown in FIG. 1, the memory 1005, as a non-volatile readable storage medium, may include an operating system, a network communication module, an application program module, and a simulation test program based on a rotating prism Lidar.

The simulation test equipment based on a rotating prism Lidar of FIG. 1, the network interface 1004 is mainly used for data communication with other devices; the user interface 1003 is mainly used for data interaction with users; the processor 1001 and the memory 1005 of the simulation test device based on the rotating prism Lidar of the present disclosure may be set in the simulation test device based on the rotating prism Lidar. The simulation test device based on the rotating prism Lidar calls the simulation testing program based on the rotating prism Lidar stored in the memory 1005 through the processor 1001, and executes the simulation test method based on the rotating prism Lidar provided in the embodiments of the present disclosure.

It should be understood that the specific embodiments described herein are only to interpret the disclosure and are not to limit the disclosure.

The traditional autonomous vehicle tests often require a lot of time and resources, and are limited by road traffic and environmental conditions. To overcome these problems, virtual simulation test is widely used in the testing and verification of autonomous vehicles. The virtual simulation environment can provide highly controllable test scenarios, while simulating a variety of complex traffic conditions and environmental conditions, so as to more comprehensively evaluate the performance and safety of autonomous vehicles. In virtual simulation tests, the accuracy and authenticity of the sensor model are crucial for the reliability of the test results.

Lidar is one of commonly used sensors for perception in autonomous vehicles, which can obtain the distance and depth of objects in surrounding environment in real time. As an important subclass of solid-state Lidar, rotating prism Lidar has unique advantages in the field of autonomous driving vehicles. The non-repetitive scanning through Risley prism can improve the comprehensiveness and stability of environmental perception and reduce occlusion and overlap problems. In addition, the rotating prism Lidar has high measurement accuracy, lower power consumption, and small volume, which is suitable for integration into autonomous vehicles. At present, most Lidar models focus on the research of traditional mechanical Lidar. Due to the complexity structure of rotating prism Lidar, there is still lack of simulation test methods for the performance of rotating prism Lidar in the relevant technologies.

To overcome the deficiencies in the aforementioned techniques, this disclosure provides a simulation test method based on a rotating prism Lidar, Firstly, obtaining a scanning trajectory model of a Lidar signal on an imaging plane, and the Lidar signal is emitted by a rotating prism Lidar; secondly, acquiring an attenuation coefficient of the Lidar signal propagating in a preset weather environment, and determining an echo signal model of the Lidar signal in the preset weather environment according to the attenuation coefficient; finally, performing a simulation test on the rotating prism Lidar based on the scanning trajectory model and the echo signal model, and the simulation test of the rotating prism Lidar is finished.

This embodiment of the disclosure provides a simulation test method based on the rotating prism Lidar, referring to FIG. 2, FIG. 2 is a flow diagram of a simulation test method based on a rotating prism Lidar according to an embodiment of the present disclosure.

In this embodiment, the simulation test method based on the rotating prism Lidar includes:
S10: obtaining a scanning trajectory model of a Lidar signal on an imaging plane, and the Lidar signal is emitted by a rotating prism Lidar.

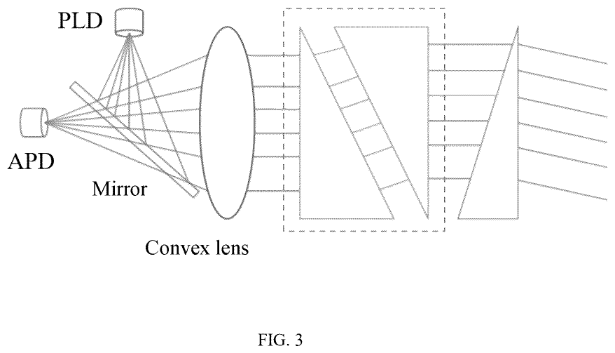

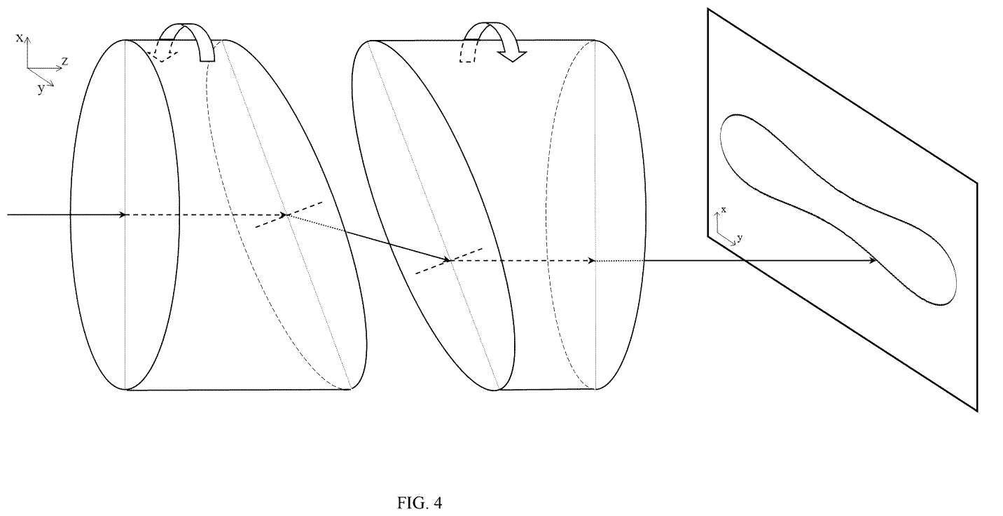

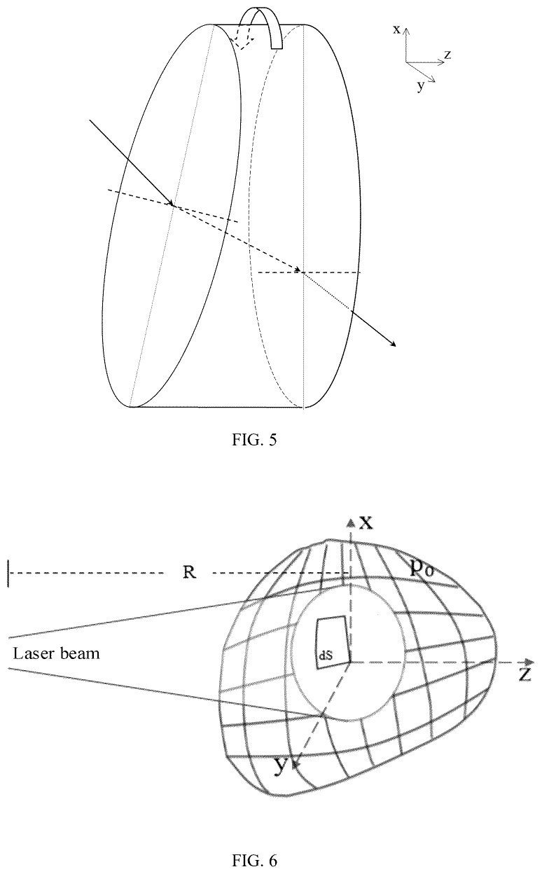

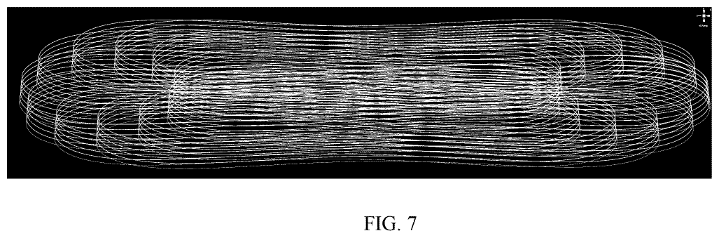

FIG. 3 is a structure diagram of the prism Lidar system according to an embodiment of the present disclosure, FIG. 4 is a structure diagram of a pair of synchronous prisms and laser beam deflection according to an embodiment of the present disclosure, and FIG. 5 is a schematic diagram of an independent rotating prism laser beam deflection according to an embodiment of the present disclosure, and FIG. 6 is a schematic diagram of a laser beam echo principle according to an embodiment of the present disclosure.

Please refer to the structure diagram of the prism Lidar system in FIG. 3, the prism Lidar system includes an avalanche photo detector (APD), a pulsed laser diode (PLD), and a mirror, and a convex lens, and three coaxial rotating prisms. A pulsed laser diode (PLD) is used for laser emission, and an avalanche photo detector (APD) is used to receive the echo signal of the Lidar. The mirror is used to selectively transmit or reflect the laser beam, and the lens is used to focus the reflected laser beam. Among them, the first two prisms in the optical path are controlled synchronously so that they rotate in the opposite direction at a same speed, the first two prisms form a pair of synchronous prisms, while the third prism is controlled to rotate independently. The rotational ratio between the first two synchronously rotating prisms and the third independently rotating prism is irreducible fraction.

In this embodiment, a mathematical model is established for the pair of synchronous prisms by a matrix method, the rotating of the pair of synchronous prisms may deflect the laser beam, and a deflection matrix R_{E}(t) is configured to express a deflection effect, and the deflection matrix R_{E}(t) is expressed as follow:

$${R}_{E} ( t ) = [ {R}_{Ω}^{- 1} ( t ) {R}_{δ} {R}_{Ω} ( t ) ] [ {R}_{- Ω}^{- 1} ( t ) {R}_{δ} {R}_{- Ω} ( t ) ] ; and$$

$${R}_{Ω} ( t ) = [ \begin{matrix}cos Ω t & sin Ω t & 0 \\ - sin Ω t & cos Ω t & 0 \\ 0 & 0 & 1\end{matrix} ] , {R}_{δ} = [ \begin{matrix}cos δ & 0 & sin δ \\ 0 & 1 & 0 \\ - sin δ & 0 & cos δ\end{matrix} ] .$$

wherein, Ω is an angular speed of the pair of synchronous prisms, R_{Ω}(t) represents a rotation matrix along a z-axis of FIG. 4, which includes location information during the rotating process of the pair of synchronous prisms, and R_{δ} represents a deflection effect matrix of each synchronous prism on laser beam, each prism may apply a rotation on the laser beam at an angle of δ (in radians) along the z-axis shown in FIG. 4.

Refer to FIG. 5, as the third prism that rotates independently, the deflection of the laser beam occurs at an interface of two planes, that are, the incident plane and the exit plane of the prism. The laser beam deflection generated by the independent rotating prism is superimposed on the outgoing laser beam of the pair of the synchronous prisms, and the scanning trajectory model produced by the independent rotating prism and the synchronous prisms on the laser beam refraction at the imaging plane of the distance sensor L can be expressed by the following parameter equation:

$$\{ \begin{matrix}{x}_{L} ( t ) = L ( 2 cos {Ω}_{1} t \cdot sin {δ}_{1} \cdot [ 1 - {cos}^{2} {Ω}_{1} t ( 1 - cos {δ}_{1} ) ] + sin {δ}_{2} cos {Ω}_{2} t ) \\ {y}_{L} ( t ) = L ( 2 {cos}^{2} {Ω}_{1} t \cdot sin {Ω}_{1} t \cdot sin {δ}_{1} ( 1 - cos {δ}_{1} ) - sin {Ω}_{1} t sin {δ}_{1} cos {δ}_{1} + cos {δ}_{2} sin {Ω}_{2} t )\end{matrix} ;$$

wherein, x_{L}(t) is a scanning trajectory in a x-axis direction at a current time t, and y_{L}(t) is a scanning trajectory in a y-axis direction, and t is the current time, and Ω₁ is a rotating speed of a pair of synchronous prisms, and δ₁ is a laser beam deflection angle caused by one synchronous prism of a pair of the synchronous prisms, and Ω₂ is a rotating speed of an independent rotating prism, and δ₂ is a laser beam deflection angle caused by the independent rotating prism, and L is a distance between the Lidar and the imaging plane.

After testing and verification, this embodiment provides a scanning trajectory model of a Lidar signal on the imaging plane through matrix analysis and vector analysis. The scanning trajectory model can accurately simulate the scanning mode and trajectory of a Lidar, enhancing the comprehensiveness and stability of the test results.

S20: acquiring an attenuation coefficient of the Lidar signal propagating in a preset weather environment, and determining an echo signal model of the Lidar signal in the preset weather environment according to the attenuation coefficient.

Generally, transmission attenuation in the atmosphere is an important factor affecting the detection performance of Lidar. Laser propagation in the atmosphere is affected by factors such as particle absorption, scattering, and macroscopic weather phenomena such as rain, snow, and fog, which can lead to atmospheric transmission attenuation of laser.

The scattering types of Lidar signals vary under different weather conditions. This embodiment provides the following mathematical model to describe the impact of different weather conditions on laser transmission.

Foggy is a weather phenomenon formed by the presence of tiny water droplets suspended in the air. Radiation fog is a situation that occurs on land mostly, which is composed of larger droplets larger than 5 to 10 μm. After testing and verification, the attenuation coefficient of Lidar in foggy weather can be expressed by the following formula:

$${β}_{fog} = \frac{0.18126 {λ}_{μ m}^{2} + 0.13709 {λ}_{μ m} + 3.7502}{V} ;$$

and
wherein, β_{fog} is the transmission attenuation of the Lidar in the foggy weather; V is visibility, measured in kilometers (Km); and λ_{μm} is wavelength of the Lidar signal, measured in micrometers (μm).

When the laser beam passes through raindrops, it undergoes scattering and absorption, resulting in a rapid decrease in laser energy. In this embodiment, after testing and verification, the following attenuation model can be used to represent the attenuation coefficient of the Lidar under rainy weather:

$${β}_{rain} = {ah}^{b} ;$$

and
wherein, h is precipitation, measured in mm/h; a and b are rainfall intensity coefficient. When the rainfall intensity coefficient is lower, a=1.076, b=0.67; when the rainfall intensity coefficient is higher, a=0.365, b=0.63.

The impact of snow on the transmission of Lidar signals is similar to that of rainy weather. In this embodiment, after testing and verification, it has been determined that the following attenuation coefficient model can be used for snowy weather:

$${β}_{snow} = 1.3029 \frac{m}{{C}_{snow}} ;$$

wherein, m is moisture content of snowflakes, measured in g/m³; and C_{snow} is snowfall coefficient, measured in g/cm²; a value of C_{snow} is related to the characteristics of snowfall. For example, in a dry snow environment, C_{snow}=0.017, and in an environment, C_{snow}=0.0724. When the surface temperature is above zero, solid snow will mix with some snowmelt liquid (with a proportion greater than 20%), making the snow more viscous and easier to condense into ice; on the contrary, when the surface temperature is below zero, the proportion of melted snow is relatively low (less than 10%) and appears as dry powders.

The attenuation coefficient of the atmosphere on laser intensity is expressed as follow:

$${β}_{atm} = - ( {β}_{fog} + {β}_{rain} + {β}_{snow} ) 2 R .$$

Finally, the attenuation coefficient corresponding to the propagation of Lidar signals under preset weather conditions can be expressed as follow:

$${β}_{atm} = - ( \frac{0.18126 {λ}_{μ m}^{2} + 0.13709 {λ}_{μ m} + 3.7502}{V} + {ah}^{b} + 1.3029 \frac{m}{{C}_{snow}} ) \cdot 2 R ;$$

wherein, βₐₜₘ is the corresponding attenuation coefficient of the Lidar signal propagating in a preset weather environment, and C_{snow} is a snowfall coefficient, and V is visibility, and λ_{μm} is a wavelength of the Lidar signal, and R is a laser transmission distance, a and b are rainfall intensity coefficients, h is precipitation, and m is a water content of snowflakes.

In the process of Lidar pulse ranging, the Lidar emits a short pulse beam to irradiate the target and measures the time delay of the pulse signal returned by the target object. By calculating a relationship between time delay and the speed of laser beam, the distance between the target and the Lidar can be determined. For example, the emitted Lidar signal is a rectangular pulse s_{rec}(t), and the echo signal sₜᵣₐ(t) can be acted as the convolution of the emitted signal and a system response h(t):

$${s}_{r e c} ( t ) = {s}_{tra} ( t ) * h ( t )$$

If the range of the target object irradiated by the laser beam is divided into area elements, the system response of each area element can be expressed as:

$$d h ( t ) = {β}_{atm} {p}_{0} ( x , y , z ) a ( x , y , z , t ) l ( t ) cos ψ ds ;$$

wherein, βₐₜₘ is an attenuation factor, and p₀(x, y, z) is a surface reflectivity function of the target object, which is determined by the surface material; a(x, y, R₀, t)=

$$\frac{2 P ( t )}{π {μ ( z )}^{2}} exp ( - 2 \frac{{x}^{2} + {y}^{2}}{{μ ( z )}^{2}} )$$

is an energy distribution function of the Lidar signal on the beam cross-section, and μ(z) is a beam cross-section radius, and P(t) is a transmission waveform of the laser beam along the emission direction after t time of emission. Comparing with the distance between the Lidar and the target object, the z-axis change of the target surface can be ignored, and the system response integral of the plane element can be expressed as:

$$h ( t ) = {β}_{atm} l ( t ) \int \int {p}_{0} ( x , y , {R}_{0} ) a ( x , y , {R}_{0} , t ) dxdy$$

For the transmission signal of rectangular pulses

$${s}_{tra} ( t ) = \{ \begin{matrix}A , {t}_{1} < {t}_{1} < {t}_{2} \\ 0 , t < {t}_{1} or t > {t}_{2}\end{matrix} ,$$

the echo signal model can be expressed as follow:

$${s}_{r e c} ( t ) = A {\int }_{{t}_{1}}^{{t}_{2}} {β}_{atm} l ( τ - t ) \int \int {p}_{0} ( x , y , {R}_{0} ) a ( x , y , {R}_{0} , τ - t ) dxdy d τ$$

and
wherein, s_{rec}(t) is the echo signal at a current time t, and A is a signal amplification of a rectangular signal in a time period of t₁ to t₂, and tis a current time, and t₁ is an emission time of rectangular signal, and t₂ is an end time of the rectangular signal, and τ is a convolution integral variable, and p₀(x, y, R₀) is a surface reflectivity function of the target object, and a (x, y, R₀, τ−t) is an energy distribution function of the Lidar signal on a beam section.

This embodiment studies the attenuation effect of different weather environments on the transmission of Lidar signals, making the final measured echo signal more accurate, making the simulation results closer to the actual scene, and improving the reliability of the test.

S30: performing a simulation test on the rotating prism Lidar based on the scanning trajectory model and the echo signal model.

For example, based on the scanning trajectory model of the Lidar signal mentioned above, the detection path of the Lidar signal in the simulation test scenario is obtained. Based on the echo signal model of the Lidar signal, the echo signal of the Lidar signal when propagating in a preset weather environment is obtained. Simulating and testing the working process of the rotating prism Lidar based on the detection path and echo signal.

According to the simulation test method based on the rotating prism Lidar of this embodiment, different parameters can be used for prism Lidar sensors, such as prism Lidar applied to different laser wavelengths, pulse repetition rates, laser powers, scanning speeds, horizontal and vertical resolutions. After testing on Lidars with different parameters, the simulation test method provided in this embodiment can ensure that the simulated object has similar performance and scanning modes to the actual sensor.

Meanwhile, this embodiment adopts ray tracing and ray detection to simulate the optical characteristics of the laser beam ranging process, simulating the interaction between the laser beam and the target object after being emitted by the sensor. Ray tracing technology can accurately simulate the propagation path of laser, including refraction in the atmosphere, reflection and scattering on the target surface. According to the Lidar echo signal model proposed in this embodiment, the simulated laser beam path data is converted into reflectance data under different weather conditions. This process considers the influence of atmospheric humidity, rain, snow, and other factors on laser transmission, generating more realistic environmental reflection data.

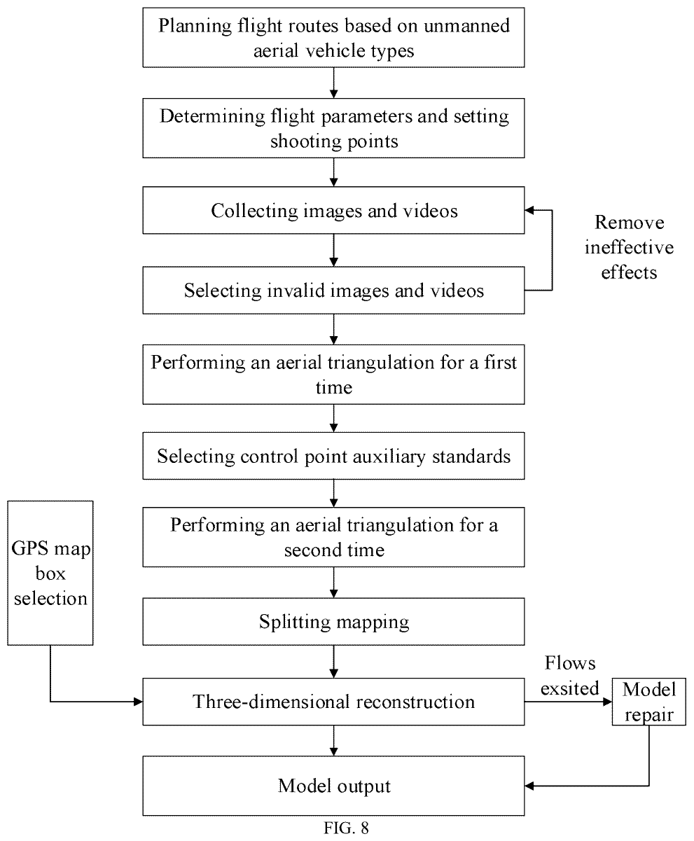

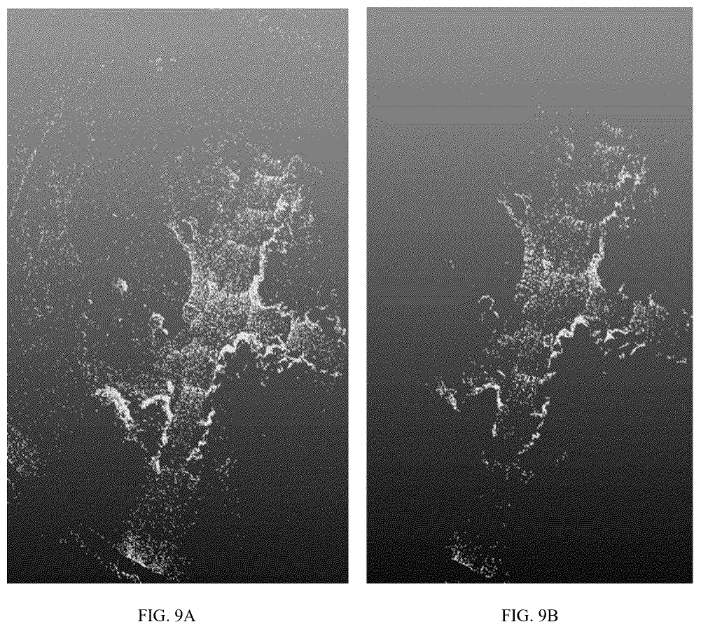

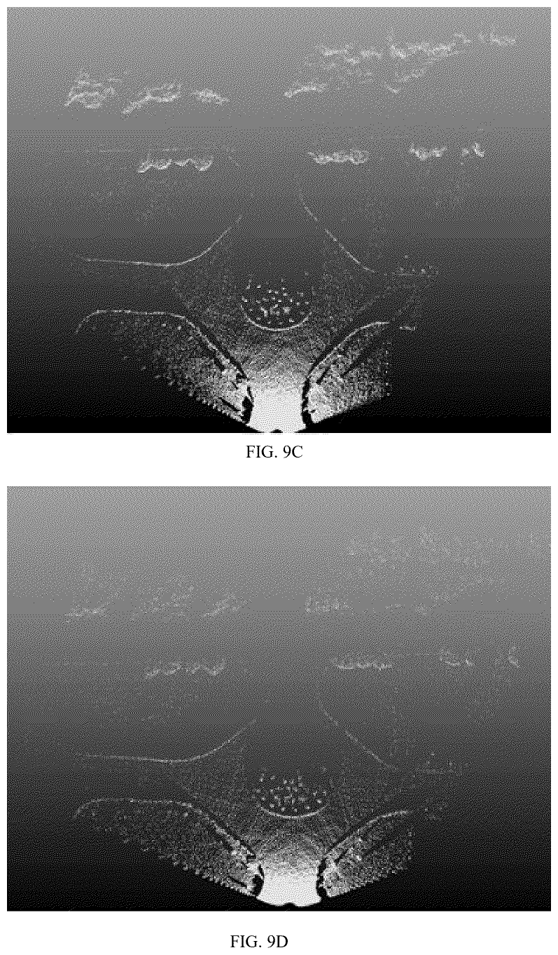

FIG. 7 is a schematic diagram of a scanning mode of a virtual sensor output according to an embodiment of the present disclosure, FIG. 8 is a schematic diagram of a digital twin scenario modeling process according to an embodiment of the present disclosure, and FIGS. 9A-9B are a virtual scene according to an embodiment of the present disclosure, and FIGS. 9C-9D are another virtual scene according to an embodiment of the present disclosure. Please refer to FIG. 8, the model of this embodiment can use unity engine for virtual point cloud output, simulating a type of prism Lidar produced in the market. The virtual Lidar includes 6 sets of transceiver units, which can expand the scanning field of view. The scanning pattern on the plane perpendicular to the sensor is shown in FIG. 7. Importing virtual test scenarios into unity engine, this embodiment adopts drone aerial photography and three-dimensional (3D) reconstruction technology to construct a digital twin test scenario of a real scene. Real unstructured data is collected through perception devices such as drones, Lidar, inertial navigation, global navigation satellite systems, panoramic cameras, etc., and the surveying data is structured. By performing operations such as point cloud matching, loop optimization, and map annotation, rich attributes and semantic information are assigned to point cloud maps to generate high-precision maps, and mature 3D reconstruction algorithms are used to construct models. During the data collection process, a drone camera is used to capture planar images of 3D objects, and the images are collected through route planning. In the model construction process, high-precision modeling is carried out through steps such as camera pose calculation, sparse reconstruction, dense reconstruction, grid matching, texture mapping, etc. The scene construction effect is shown in FIG. 9, which has high visual realism. The next step is to manually label the reflectivity of different objects in the virtual scene to distinguish different elements such as rough driving roads and smooth traffic signs.

When collecting virtual point cloud data, the emission and echo of the laser beam are simulated through ray detection and physical simulation methods. When the laser beam hits an object in the virtual scene, the reflectivity marker mentioned above is used to calculate the transmission loss under different simulated weather conditions, and the intensity of the laser beam echo is obtained. Encapsulate the intensity and point cloud coordinates in the data format of the corresponding model of Lidar, transmit them using user data protocol (UDP), and enable them to be read and visualized by the corresponding model of Lidar upper computer software. Please refer to FIGS. 9A-9B, FIGS. 9A-9B show two sets of point cloud data for sunny weather, and refers to FIGS. 9C-9D, FIGS. 9C-9D show two sets of point cloud data for foggy weather. This embodiment can seamlessly integrate with real Lidar upper computer software, providing effective test and verification methods for actual system integration.

The following describes a simulation test device based on a rotating prism Lidar provided by the present disclosure. The simulation test device based on the rotating prism Lidar described below is corresponded to the simulation test method based on the rotating prism Lidar described above.

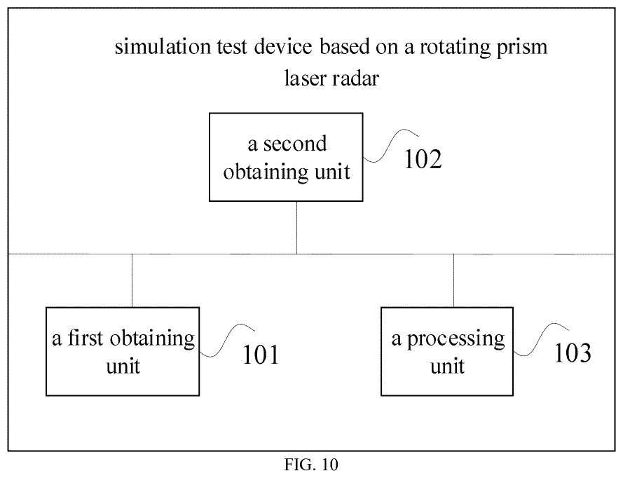

FIG. 10 is a structure diagram of a simulation test device based on a rotating prism Lidar according to an embodiment of the present disclosure, please refers to FIG. 10, the simulation test device includes:
a first obtaining unit 101, configured for obtaining a scanning trajectory model of a Lidar signal on an imaging plane of, and the Lidar signal is emitted by a rotating prism Lidar; and
a second obtaining unit 102, configured for acquiring an attenuation coefficient of the Lidar signal propagating in a preset weather environment, and determining an echo signal model of the Lidar signal in the preset weather environment according to the attenuation coefficient; and
a processing unit 103, configured for performing a simulation test on the rotating prism Lidar based on the scanning trajectory model and the echo signal model.

In one embodiment, the scanning trajectory model is expressed as follow:

$$\{ \begin{matrix}{x}_{L} ( t ) = L ( 2 cos {Ω}_{1} t \cdot sin {δ}_{1} \cdot [ 1 - {cos}^{2} {Ω}_{1} t ( 1 - cos {δ}_{1} ) ] + sin {δ}_{2} cos {Ω}_{2} t ) \\ \begin{matrix}{y}_{L} ( t ) = L ( 2 {cos}^{2} {Ω}_{1} t \cdot sin {Ω}_{1} t \cdot sin {δ}_{1} ( 1 - cos {δ}_{1} ) - \\ sin {Ω}_{1} t sin {δ}_{1} cos {δ}_{1} + cos {δ}_{2} sin {Ω}_{2} t )\end{matrix}\end{matrix} ;$$

wherein, x_{L}(t) is a scanning trajectory in a x-axis direction at current time t, and y_{L}(t) is a scanning trajectory in a y-axis direction, and t is the current time, and Ω₁ is a rotating speed of a pair of synchronous prisms, and δ₁ is a laser beam deflection angle caused by one synchronous prism of a pair of the synchronous prisms, and Ω₂ is a rotating speed of an independent rotating prism, and δ₂ is a laser beam deflection angle caused by the independent rotating prism, and L is a distance between the Lidar and the imaging plane.

In one embodiment, the attenuation coefficient is expressed as follow:

$${β}_{atm} = - ( \frac{0.18126 {λ}_{μ m}^{2} + 0.13709 {λ}_{μ m} + 3.7502}{V} + a {h}^{b} + 1.3029 \frac{m}{{c}_{s n o w}} ) \cdot 2 R ;$$

and
wherein, βₐₜₘ is the corresponding attenuation coefficient of the Lidar signal propagating in a preset weather environment, and C_{snow} is a snowfall coefficient, and V is visibility, and λ_{μm} is a wavelength of the Lidar signal, and R is a laser transmission distance, a and b are rainfall intensity coefficients, h is precipitation, and m is a water content of snowflakes.

In one embodiment, the echo signal model is expressed as follow:

$${s}_{r e c} ( t ) = A {\int }_{{t}_{1}}^{{t}_{2}} {β}_{atm} l ( τ - t ) \int \int {p}_{0} ( x , y , {R}_{0} ) a ( x , y , {R}_{0} , τ - t ) dxdy d τ$$

and
wherein, s_{rec}(t) is the echo signal at the current time t, and A is a signal amplification of a rectangular signal in a time period of t₁ to t₂, and t is a current time, and t₁ is an emission time of a rectangular signal, and t₂ is an end time of the rectangular signal, and τ is a convolution integral variable, and p₀(x, y, R₀) is a surface reflectivity function of the target object, and a(x, y, R₀, τ−t) is an energy distribution function of the Lidar signal on a beam section.

In one embodiment, the processing unit 103 is configured for obtaining a detecting path of the Lidar signal in a simulation test scenario according to the scanning trajectory model of the Lidar signal, and acquiring an echo signal of the Lidar signal propagating in the preset weather environment according to the echo signal model; and also configured for performing the simulation test on a working process of the rotating prism Lidar based on the detecting path and echo signal.

This embodiment also provides a storage medium on which a computer program is stored. When the computer program is executed by a processor, the simulation testing method based on a rotating prism Lidar as described above is implemented.

It should be noted that in this disclosure, the terms “include”, “comprise” or any other variation thereof are intended to encompass non-exclusive inclusion, such that a process, method, article, or system that includes a series of elements not only includes those elements, but also includes other elements not explicitly listed, or also includes elements inherent to such a process, method, article, or system. Without further limitations, the element limited by the statement “comprising a . . . ” does not exclude the existence of other identical elements in the process, method, item, or system that includes that element.

The above embodiments of the present disclosure are numbered for description only and do not represent the advantages or disadvantages of the embodiments.

Through the description of the above implementation methods, technical personnel in this field can clearly understand that the above implementation methods can be implemented through software and necessary general hardware platforms. Of course, they can also be implemented through hardware, but in many cases, the former is the better implementation method. Based on this understanding, the technical solutions of the present disclosure, which essentially or contributes to the existing technology, can be embodied in the form of a software product. The computer software product is stored in a storage medium (such as ROM/RAM, magnetic disk, optical disk) as described above, and includes several instructions to enable a terminal device (which can be a mobile phone, computer, server, or network device, etc.) to execute the methods described in various embodiments of the present disclosure.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A simulation test method based on a rotating prism Lidar, wherein, comprising:
S10: obtaining a scanning trajectory model of a Lidar signal on an imaging plane, and the Lidar signal is emitted by a rotating prism Lidar;
S20: acquiring an attenuation coefficient of the Lidar signal propagating in a preset weather environment, and determining an echo signal model of the Lidar signal in the preset weather environment according to the attenuation coefficient;
S30: performing a simulation test on the rotating prism Lidar based on the scanning trajectory model and the echo signal model.

2. The simulation test method based on the rotating prism Lidar of claim 1, wherein in S10, the scanning trajectory model is expressed as follow:
$$\{ \begin{matrix}{x}_{L} ( t ) = L ( 2 cos {Ω}_{1} t \cdot sin {δ}_{1} \cdot [ 1 - {cos}^{2} {Ω}_{1} t ( 1 - cos {δ}_{1} ) ] + sin {δ}_{2} cos {Ω}_{2} t ) \\ \begin{matrix}{y}_{L} ( t ) = L ( 2 {cos}^{2} {Ω}_{1} t \cdot sin {Ω}_{1} t \cdot sin {δ}_{1} ( 1 - cos {δ}_{1} ) - \\ sin {Ω}_{1} t sin {δ}_{1} cos {δ}_{1} + cos {δ}_{2} sin {Ω}_{2} t )\end{matrix}\end{matrix} ;$$
wherein, x_{L}(t) is a scanning trajectory in a x-axis direction, and y_{L}(t) is a scanning trajectory in a y-axis direction, and t is a time, and Ω₁ is a rotating speed of a pair of synchronous prisms, and δ₁ is a laser beam deflection angle caused by one synchronous prism of a pair of the synchronous prisms, and Ω₂ is a rotating speed of an independent rotating prism, and δ₂ is a laser beam deflection angle caused by the independent rotating prism, and Lis a distance between the Lidar and the imaging plane.

3. The simulation test method based on the rotating prism Lidar of claim 1, wherein in S20, the attenuation coefficient is expressed as follow:
$${β}_{atm} = - ( \frac{0.18126 {λ}_{μ m}^{2} + 0.13709 {λ}_{μ m} + 3.7502}{V} + a {h}^{b} + 1.3029 \frac{m}{{c}_{s n o w}} ) \cdot 2 R ;$$
wherein, βₐₜₘ is the corresponding attenuation coefficient of the Lidar signal propagating in the preset weather environment, and C_{snow} is a snowfall coefficient, and V is visibility, and λ_{μm} is a wavelength of Lidar signal, and R is a laser transmission distance, a and b are rainfall intensity coefficients, h is precipitation, and m is a water content of snowflakes.

4. The simulation test method based on the rotating prism Lidar of claim 2, wherein, in S20, the echo signal model is expressed as follow:
$${s}_{r e c} ( t ) = A {\int }_{{t}_{1}}^{{t}_{2}} {β}_{atm} l ( τ - t ) \int \int {p}_{0} ( x , y , {R}_{0} ) a ( x , y , {R}_{0} , τ - t ) dxdy d τ$$
wherein, s_{rec}(t) is the echo signal at the time t, and A is a signal amplification of a rectangular signal in a time period of t₁ to t₂, and tis a current time, and t₁ is an emission time of a rectangular signal, and t₂ is an end time of the rectangular signal, and τ is a convolution integral variable, and p₀(x, y, R₀) is a surface reflectivity function of a target object, and a (x, y, R₀, τ−t) is an energy distribution function of the Lidar signal on a beam section.

5. The simulation test method based on the rotating prism Lidar of claim 4, wherein the S30 comprises following steps:
S31: obtaining a detecting path of the Lidar signal in a simulation test scenario according to the scanning trajectory model of the Lidar signal, and acquiring an echo signal of the Lidar signal propagating in the preset weather environment according to the echo signal model;
S32: performing the simulation test on a working process of the rotating prism Lidar based on the detecting path and the echo signal.

6. The simulation test method based on the rotating prism Lidar of claim 1, wherein in S20, the attenuation coefficient is expressed as follow:
$${β}_{atm} = - ( {β}_{f o g} + {β}_{r a i n} + {β}_{s n o w} ) 2 R ;$$
wherein, βₐₜₘ is the attenuation coefficient of the Lidar signal in the preset weather environment, and β_{fog} is an attenuation coefficient of the Lidar signal in foggy weather, and βᵣₐᵢₙ is an attenuation coefficient of the Lidar signal in rainy weather, and β_{snow} is an attenuation coefficient of the Lidar signal in snowy weather, and R is the laser transmission distance.

7. A simulation test device based on a rotating prism Lidar, wherein comprising:
a first obtaining unit, configured for obtaining a scanning trajectory model of a Lidar signal on an imaging plane, and the Lidar signal is emitted by a rotating prism Lidar;
a second obtaining unit, configured for acquiring an attenuation coefficient of the Lidar signal propagating in a preset weather environment, and determining an echo signal model of the Lidar signal in the preset weather environment according to the attenuation coefficient;
a processing unit, configured for performing a simulation test on the rotating prism Lidar based on the scanning trajectory model and the echo signal model.

8. The simulation test device based on the rotating prism Lidar of claim 7, wherein the scanning trajectory model is expressed as follow:
$$\{ \begin{matrix}{x}_{L} ( t ) = L ( 2 cos {Ω}_{1} t \cdot sin {δ}_{1} \cdot [ 1 - {cos}^{2} {Ω}_{1} t ( 1 - cos {δ}_{1} ) ] + sin {δ}_{2} cos {Ω}_{2} t ) \\ \begin{matrix}{y}_{L} ( t ) = L ( 2 {cos}^{2} {Ω}_{1} t \cdot sin {Ω}_{1} t \cdot sin {δ}_{1} ( 1 - cos {δ}_{1} ) - \\ sin {Ω}_{1} t sin {δ}_{1} cos {δ}_{1} + cos {δ}_{2} sin {Ω}_{2} t )\end{matrix}\end{matrix} ;$$
wherein, x_{L}(t) is a scanning trajectory in a x-axis direction, and y_{L}(t) is a scanning trajectory in a y-axis direction, and tis a time, and Ω₁ is a rotating speed of synchronous prism pairs, and δ₁ is a laser beam deflection angle caused by one synchronous prism of a pair of synchronous prisms, and Ω₂ is a rotating speed of an independent rotating prism, and δ₂ is a laser beam deflection angle caused by the independent rotating prism, and Lis a distance between the Lidar and the imaging plane.

9. The simulation test device based on the rotating prism Lidar of claim 7, wherein the echo signal model is expressed as follow:
$${s}_{r e c} ( t ) = A {\int }_{{t}_{1}}^{{t}_{2}} {β}_{atm} l ( τ - t ) \int \int {p}_{0} ( x , y , {R}_{0} ) a ( x , y , {R}_{0} , τ - t ) dxdy d τ$$
wherein, s_{rec}(t) the echo signal, and A is a signal amplification of a rectangular signal in a time period of t₁ to t₂, and t is a current time, and t₁ is an emission time of a rectangular signal, and t₂ is an end time of the rectangular signal, and τ is a convolution integral variable, and p₀(x, y, R₀) is a surface reflectivity function of the target object, and a (x, y, R₀, τ−t) is an energy distribution function of the Lidar signal on a beam section.

10. A computer readable storage medium, wherein, the computer readable storage medium comprises a simulation test program based on a rotating prism Lidar, when the simulation test program based on the rotating prism Lidar is called by a processor, a simulation test method based on a rotating prism Lidar of claim 1 is achieved.
